(19) United States
(12) Patent Application Publication
(10) Pub. No.: US 2019/0236076 A1
(43) Pub. Date: Aug. 1, 2019

(54) COMPUTER AND CACHE CONTROL METHOD

(71) Applicant: HITACHI, LTD., Tokyo (JP)

(72) Inventors: Nobukazu KONDO, Tokyo (JP); Naruki KURATA, Tokyo (JP); Katsuto SATO, Tokyo (JP)

(73) Assignee: HITACHI, LTD., Tokyo (JP)

(21) Appl. No.: 16/335,112

(22) PCT Filed: Feb. 24, 2017
(86) PCT No.: PCT/JP2017/007168

§ 371 Date: Mar. 20, 2019

(51) Int. Cl. G06F 16/25; G06F 16/2455

(52) U.S. Cl. CPC G06F 16/256; G06F 16/24552

(57) ABSTRACT

Provided is a computer generating a virtual database. The computer is connected to a plurality of databases systems managing a database and a cache memory system providing a cache area, holds virtual database management information for managing a plurality of databases constituting the virtual database, cache management information, and latency information for managing a latency when data is acquired from the databases, and selects a cache area from which cache data is to be deleted, based on an evaluation value calculated using the cache management information and the latency information in a case where the cache area for storing the data acquired in a case where a query for referring to the virtual database is received is not sufficient.

### TECHNICAL FIELD

The present invention relates to cache control in a virtual database system.

### BACKGROUND ART

In recent years, a technique for realizing a virtual database system in which a plurality of database systems having different interfaces, data structures, management methods, and the like are virtually integrated has attracted attention (see, for example, PTL 1 and PTL 2).

PTL 1 discloses that “a logical database dictionary for holding information on a logical database in which one or more databases are grouped, a logical database definition unit that registers information on the logical database in the logical database dictionary, a syntax buffer for holding an access syntax to a database, a logical database access control unit that receives an access syntax from application program execution means and stores the received access syntax in the syntax buffer, and a table position retrieval unit that transmits the access syntax held in the syntax buffer to a physical database management system managing a physical database with any one of the databases belonging to the logical database as an object to be accessed are included”.

In addition, PTL 2 discloses that “a database system management device having a plurality of database systems connected thereto to output data according to access from a user system includes: a database management part 22 storing physical database management information and logical database management information; an query sentence generation part 25 for performing conversion of an query sentence due to the generation of a sub query sentence and data rearrangement by the sub query sentence in a database system unit; an execution result estimation part 26 for estimating an execution result size of a given query sentence; an query input analysis part 24 for determining data arrangement of the sub query sentence generated and converted by the query sentence generation part based on the execution result size estimated by the execution result estimation part, and updating the logical database management information; and an query execution part 28 for executing an execution plan of a series of sub query sentences generated by the query input analysis part”.

### CITATION LIST

### Patent Literature

PTL 1: JP-A-7-98669

PTL 2: JP-A-2016-91356

PTL 3: JP-A-2006-92409

PTL 4: US 2013/0060810

### SUMMARY OF INVENTION

### Technical Problem

A device having a function for realizing a virtual database system is connected to a plurality of database systems through a network. In a case where the device receives a request for referring to a virtual database provided by the virtual database system from a user, the device is required to access each database system and acquire data. Therefore, there is a problem that a period of time from when the request for referring to the virtual database is received from the user to when the virtual database system is presented is increased.

With respect to the problem, using a cache is considered (see, for example, PTL 3). In addition, cache control methods such as least recently used (LRU) and least frequently used (LFU) and a control method disclosed in PTL 4 are known as cache algorithms.

PTL 3 discloses that a cache file storing column information on a plurality of databases is created. Further, in paragraphs “0033”, “0034”, and the like of PTL 4, a method in which a smart cache device determines whether or not data is cached based on a period of time having elapsed from reception of a previous query is described.

Since the virtual database system is connected to a plurality of database systems, it takes time to acquire data. That is, a bottleneck (latency) occurs due to connection between the systems. However, in cache algorithms of the related art such as LRU and LFU, the above-described latency is not taken into account.

Here, it is assumed that first data and second data are stored in a cache memory and any one piece of the data is removed from the cache memory. Meanwhile, the first data is stored in an internal storage device, the number of times the first data is referred to is set to “100”, the second data is stored in a storage device connected through a network, and the number of times the second data is referred to is set to “80”. In a case of cache control using an LFU method, the second data is removed from the cache memory. However, since an acquisition time of the second data is longer than an acquisition time of the first data, there is a possibility that reference performance is more improved when the first data is removed.

In addition, the elapsed time described in PTL 4 is a fixed value and is not a time obtained by taking a latency between the database systems into account.

An object of the present invention is to provide a device and a method for realizing cache control for improving reference performance of a virtual database in consideration of a latency caused by connection between database systems.

### Solution to Problem

A representative example of the present invention is as follows. That is, there is provided a computer that generates a virtual database generated by integrating a plurality of databases, the computer including a processor, a memory connected to the processor, a network interface connected to the processor, and a connection interface connected to the processor, in which the computer is connected to a plurality of databases systems managing a database and a cache memory system providing a cache area for storing data acquired from the database, the computer holds virtual database management information for managing a plurality of databases constituting the virtual database, cache management information used for cache control, and latency information for managing a latency when data is acquired from the databases, and the processor specifies a plurality of target databases constituting the virtual database based on analysis results of a query and the virtual database management information when the query for referring to the virtual database is received, acquires data in which cache data is stored in the cache memory system, among pieces of data of the plurality of target databases, from the cache memory system, acquires data in which cache data is not stored in the cache memory system, among pieces of data of the plurality of target databases, from the plurality of target databases, generates the virtual database using the cache data acquired from the cache memory system and the data acquired from the plurality of specified databases, calculates an evaluation value of the cache area based on the cache management information and the latency information in a case where the cache area for storing the data acquired from the plurality of target databases is not sufficient, selects the cache area from which cache data is to be deleted, based on the evaluation value, and stores the data acquired from the plurality of target databases in the selected cache area.

### Advantageous Effects of Invention

According to the present invention, it is possible to realize cache control for improving reference performance of a virtual database. Problems, configurations, and effects other than those described above become apparent by the description of the following examples.

### BRIEF DESCRIPTION OF DRAWINGS

FIG. 1 is a diagram showing an example of a configuration of a computer system for realizing a virtual database system of Example 1.

FIG. 2 is a diagram showing an example of detailed configurations of a virtual database system management device and a cache memory system of Example 1.

FIG. 3 is a diagram showing an example of virtual database management information of Example 1.

FIG. 4A is a diagram showing an example of cache management information of Example 1.

FIG. 4B is a diagram showing an example of the cache management information of Example 1.

FIG. 5 is a diagram showing an example of latency information of Example 1.

FIG. 6A is a flowchart illustrating an example of processing executed by a virtual database system management module of Example 1.

FIG. 6B is a flowchart illustrating an example of processing executed by the virtual database system management module of Example 1.

FIG. 7 is a flowchart illustrating an example of processing executed by an OS of Example 1.

FIG. 8 is a flowchart illustrating an example of processing in a case where a cache driver of Example 1 retrieves cache data.

FIG. 9 is a flowchart illustrating an example of processing in a case where the cache driver of Example 1 stores data in a cache area.

FIG. 10A is a flowchart illustrating an example of processing executed by a virtual database system management module of Example 2.

FIG. 10B is a flowchart illustrating an example of processing executed by the virtual database system management module of Example 2.

FIG. 11A is a flowchart illustrating an example of processing in a case where a cache driver of Example 2 stores data in a cache area.

FIG. 11B is a flowchart illustrating an example of processing in a case where the cache driver of Example 2 stores data in a cache area.

FIG. 12 is a diagram showing an example of detailed configurations of a virtual database system management device and a cache memory system of Example 3.

FIG. 13A is a flowchart illustrating an example of processing executed by a virtual database system management module of Example 3

FIG. 13B is a flowchart illustrating an example of processing executed by the virtual database system management module of Example 3.

### DESCRIPTION OF EMBODIMENTS

Hereinafter, an embodiment of the present invention will be described in detail with reference to the accompanying drawings.

### Example 1

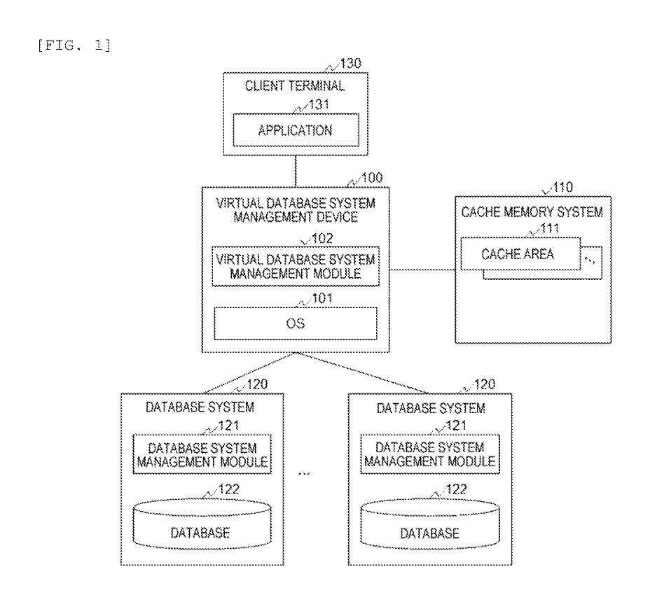

FIG. 1 is a diagram showing an example of a configuration of a computer system for realizing a virtual database system of Example 1.

The computer system includes a virtual database system management device 100, a cache memory system 110, a plurality of database systems 120, and a client terminal 130.

The virtual database system management device 100 and the client terminal 130 are connected to each other directly or through a network. The virtual database system management device 100 and the database system 120 are connected to each other through a network. Meanwhile, at least one database system 120 maybe directly connected to the virtual database system management device 100.

The database system 120 manages a database 122 defined based on a predetermined schema. The database system 120 includes a controller and a plurality of storage mediums. A hard disk drive (HDD), a solid state drive (SSD), and the like are conceivable as the storage mediums. The database system 120 includes a database system management module 121. The database system management module 121 manages a database 122, and controls various operations for the database 122.

Meanwhile, the database system 120 may be realized using a system disposed at a base in a different area or may be realized by using a cloud system.

The virtual database system management device 100 generates a virtual database defined based on a predetermined schema by virtually integrating databases 122 respectively managed by the plurality of database systems 120. The virtual database system management device 100 includes an OS 101 and a virtual database system management module 102. The virtual database system management module 102 generates and manages a virtual database.

The cache memory system 110 provides a cache area 111 used by the virtual database system management device 100. Cache data in units of a block is stored in the cache area 111. Meanwhile, using a buffer cache is conceivable as a method of managing data in units of a block. The buffer cache is generated by allocating a buffer page to a storage area of the cache memory system 110 and dividing the buffer page into block buffers having a predetermined block size.

The client terminal 130 is a terminal used by a user operating a virtual database. The client terminal 130 includes an application 131 for operating the virtual database. For example, the application 131 issues a query for referring to the virtual database. The client terminal 130 includes a processor, a memory, a network interface, an input device, and an output device which are not shown in the drawing. Meanwhile, the input device includes a keyboard, a mouse, a touch panel, and the like, and the output device includes a touch panel, a display, and the like.

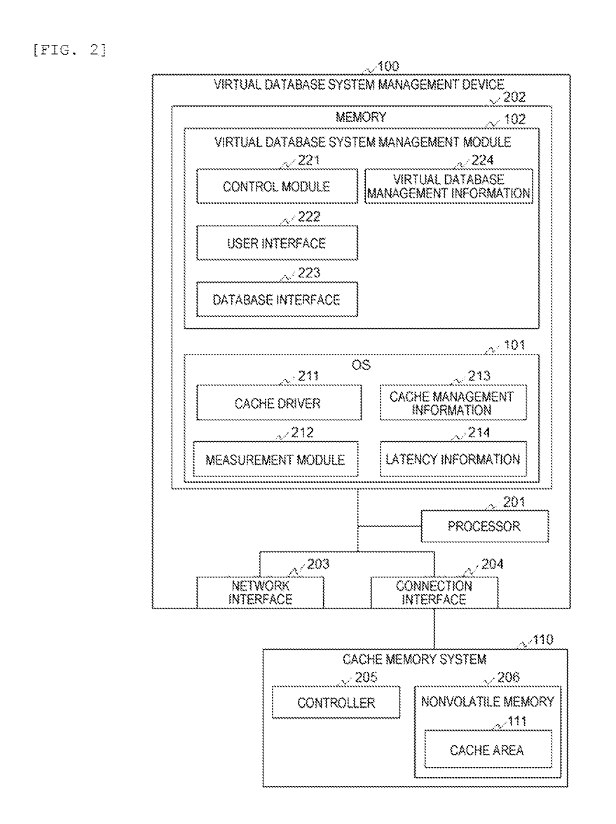

FIG. 2 is a diagram showing an example of detailed configurations of the virtual database system management device 100 and the cache memory system 110 of Example 1.

The virtual database system management device 100 includes a processor 201, a memory 202, a network interface 203, and a connection interface 204 as hardware.

The processor 201 executes programs stored in the memory 202. The processor 201 operates as a module having a predetermined function by executing processing according to a program. In the following description, the description of a module as a subject indicates that the processor 201 is operating according to a program for realizing the module.

The memory 202 stores programs executed by the processor 201 and information required to execute the programs. In addition, the memory 202 includes a work area used by a program. The memory 202 of the present example stores programs for realizing the OS 101 and the virtual database system management module 102.

The network interface 203 is an interface for connection to other devices through a network. The virtual database system management device 100 of the present example is connected to the database systems 120 and the client terminal 130 through the network interface 203.

The connection interface 204 is an interface for connection to the cache memory system 110. It is assumed that the virtual database system management device 100 and the cache memory system 110 of the present example are connected to each other through a PCIe bus. In this case, the PCIe interface is used as the connection interface 204.

The cache memory system 110 includes a controller 205 and a nonvolatile memory 206 as hardware.

The controller 205 controls the entire cache memory system 110. The controller 205 includes a processor, a memory, a connection interface, and the like.

The nonvolatile memory 206 provides a storage area used for the cache area 111. A flash memory and the like are conceivable as the nonvolatile memory 206.

Here, a program stored in the memory 202 will be described.

The OS 101 controls the entire virtual database system management device 100. The OS 101 includes a cache driver 211 and a measurement module 212 and manages cache management information 213 and latency information 214.

The cache driver 211 is a device driver that controls the cache memory system 110. In the present example, the cache area 111 is used to generate a virtual database at high speed.

The measurement module 212 measures a latency caused by connection between the virtual database system management device 100 and the database system 120. Specifically, the measurement module 212 measures a period of time from when the virtual database system management device 100 issues a query to each of the database systems 120 to when a response is received (a period of time of acquisition of data from the database system 120) as a latency.

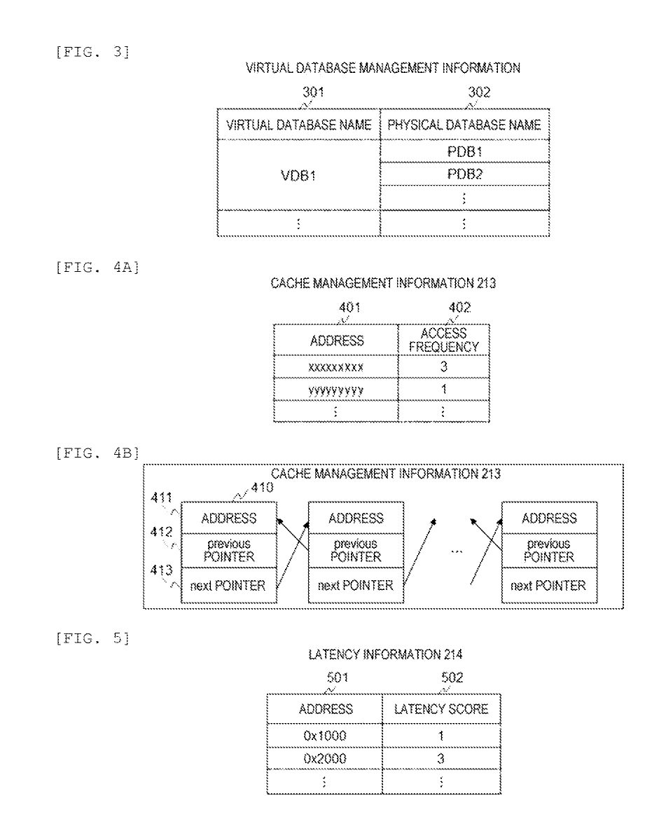

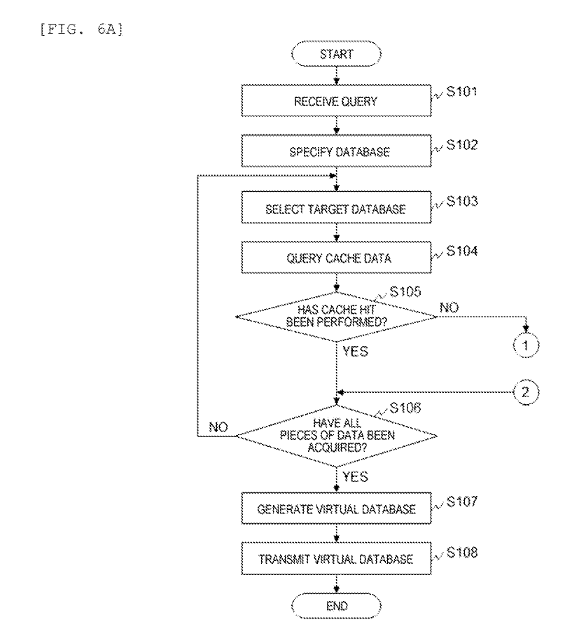

The cache management information 213 is information used for cache control corresponding to a cache algorithm. For example, in a case where an LRU method is adopted, an LRU list corresponds to the cache management information 213. A specific example of the cache management information 213 will be described using FIGS. 4A and 45.

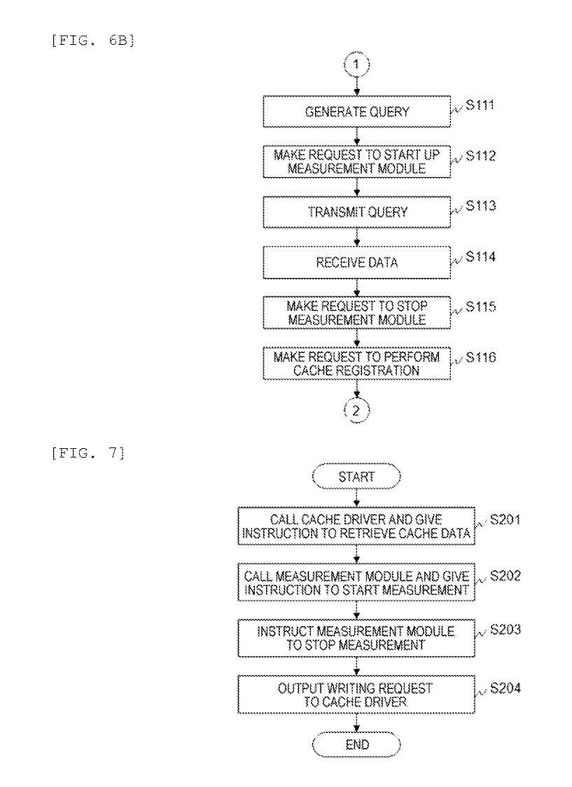

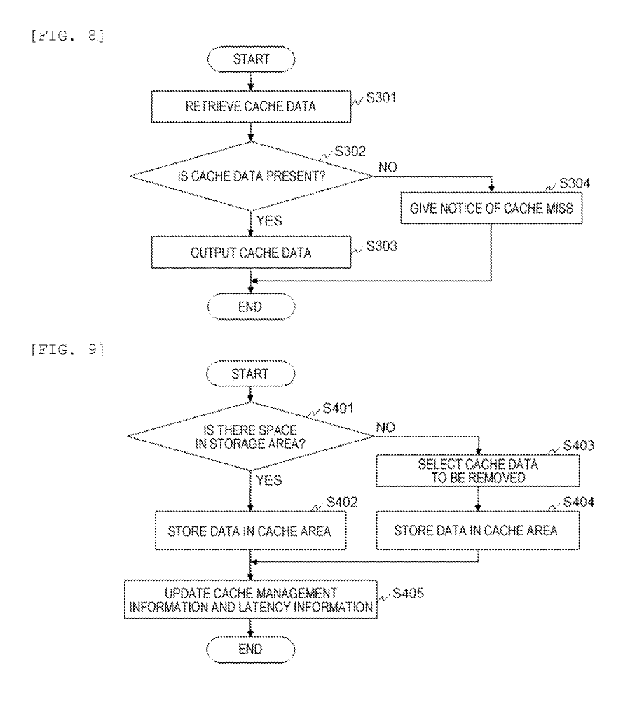

The latency information 214 is information for managing a latency related to data stored in the cache area 111. The latency information 214 will be described in detail using FIG. 6.

The virtual database system management module 102 includes a control module 221, a user interface 222, and a database interface 223 and manages virtual database management information 224.

The control module 221 controls the entire virtual database system management module 102. The control module 221 analyzes a query received from the client terminal 130 to specify the database system 120 which is an access destination, and issues a query for accessing the specified database system 120. In addition, the control module 221 generates a virtual database using data acquired from the database system 120 and transmits the generated virtual database to the client terminal 130.

Meanwhile, since a process of analyzing a query received from the client terminal 130, a process of issuing a query to be output to the database system 120, and a process of generating a virtual database are known processes, details thereof will not be described.

The user interface 222 is an interface for the client terminal 130 to operate a virtual database. The user interface 222 receives a query issued by the client terminal 130 and outputs the received query to the control module 221. In addition, the user interface 222 transmits a virtual database generated by the control module 221 to the client terminal 130.

The database interface 223 is an interface for operating the plurality of database systems 120. The database interface 223 transmits a query issued by the control module 221 to the database system 120 and outputs data acquired from the database 122 to the control module 221.

The virtual database management information 224 is information for managing a configuration of a virtual database. The virtual database management information 224 will be described in detail using FIG. 3. Meanwhile, information for managing a configuration of the database 122 may be stored in the memory 202.

FIG. 3 is a diagram showing an example of the virtual database management information 224 of Example 1.

The virtual database management information 224 includes an entry constituted by a virtual database name 301 and a physical database name 302. One entry corresponds to one virtual database.

The virtual database name 301 is a field in which the name of a virtual database is stored. The physical database name 302 is a field in which the name of the database 122 is stored. One entry includes as many rows as the databases 122 constituting a virtual database. Meanwhile, in a case where a virtual database is data in a table format, the virtual database may be information in which a field and the database 122 are associated with each other.

Meanwhile, identification information such as an ID may be used instead of the names of the virtual database and the database 122.

FIGS. 4A and 4B are diagrams showing an example of the cache management information 213 of Example 1. FIG. 4A shows an example of the cache management information 213 used for an LFU-type cache algorithm. FIG. 4B shows an example of the cache management information 213 used for an LRU-type cache algorithm.

The cache management information 213 shown in FIG. 4A includes an entry constituted by an address 401 and an access frequency 402.

The address 401 is a field in which an address of the cache area 111 is stored. The access frequency 402 is a field in which the number of times of access to the cache area 111 corresponding to the address 401 is stored.

The cache management information 213 shown in FIG. 4B is a list of structures 410. The structure 410 includes an address 411, a previous pointer 412, and a next pointer 413. In the present example, the structure 410 corresponding to the recently accessed cache area 111 is managed to be disposed on the leftmost side.

The address 411 is an address which is the same as the address 401. The previous pointer 412 is a field in which a pointer indicating a previous structure 410 is stored. The next pointer 413 is a field in which a pointer indicating the next structure 410 is stored.

Meanwhile, the cache management information 213 shown in FIGS. 4A and 4B is merely an example and the present invention is not limited thereto.

FIG. 5 is a diagram showing an example of the latency information 214 of Example 1.

The latency information 214 includes an entry constituted by an address 510 and a latency score 502. One entry corresponds to one cache area 111 in which data is stored.

The address 510 is a field in which an address of the cache area 111 storing data is stored. The latency score 502 is a field in which a value calculated based on a latency at the time of acquisition of data stored in the cache area 111 corresponding to the address 510 is stored.

In the present example, it is assumed that a function for calculating a score from a latency is given in advance. For example, a score is set to “1” in a case where a latency is smaller than 100 μs, a score is set to “2” in a case where a latency is equal to or greater than 100 μs and smaller than 500 ms, and a score is set to “3” in a case where a latency is equal to or greater than 500 ms.

FIGS. 6A and 6B are flowcharts illustrating an example of processing executed by the virtual database system management module 102 of Example 1.

The user interface 222 receives a query for referring to a virtual database from the client terminal 130 (step S101). The query includes at least the name of a virtual database. The user interface 222 outputs the received query to the control module 221.

Next, the control module 221 specifies a database 122 which is an access destination based on analysis results of the query (step S102).

Specifically, the control module 221 acquires the name of a virtual database from the query. The control module 221 retrieves an entry in which the virtual database name 301 is consistent with the name of the database acquired from the query, with reference to the virtual database management information 224.

Next, the control module 221 selects a target database 122 from among the specified databases 122 (step S103).

Specifically, the control module 221 selects one of the names of the databases 122 included in the retrieved entry.

Next, the control module 221 inquires of the OS 101 whether or not data of the target database 122 is stored in the cache memory system 110 (step S104). The control module 221 determines whether or not a cache hit has been performed based on a response from the OS 101 (step S105). For example, in a case where data is included in the response, the control module 221 determines that a cache hit has been performed.

In a case of a cache hit, the control module 221 proceeds to step S106. In this case, the control module 221 stores cache data read out by the cache driver 211 in a work area.

In a case of a cache miss, the control module 221 generates a query for acquiring data from the target database 122 (step S111). In addition, the control module 221 requests the OS 101 to start up the measurement module 212 (step S112) and transmits the generated query to the target database 122 (step S113).

In a case where the control module 221 receives data from the target database 122 through the database interface 223 (step S114), the control module stores the received data in a work area. In addition, the control module 221 requests the OS 101 to stop the measurement module 212 (step S115). In addition, the control module 221 outputs a cache registration request for registering the data stored in the work area in the cache area ill to the OS 101 (step S116). Thereafter, the control module 221 proceeds to step S106.

In a case where a determination result in step S106 is YES or the process of step S116 has been completed, the control module 221 determines whether or not data has been acquired from all of the specified databases 122 (step S106).

In a case where it is determined that data has not been acquired from all of the specified databases 122, the control module 221 returns to step S103 to execute the same process.

In a case where it is determined that data has been acquired from all of the specified databases 122, the control module 221 generates a virtual database using the data acquired from the databases 122 and the cache memory system 110 (step S107).

The control module 221 transmits the generated virtual database to the client terminal 130 through the user interface 222 (step S108).

FIG. 7 is a flowchart illustrating an example of processing executed by the OS 101 of Example 1.

In a case where the OS 101 receives a query for cache data from the control module 221, the OS calls the cache driver 211 to instruct the cache driver to retrieve cache data (step S201).

In a case where the OS 101 receives a request for starting up the measurement module 212 from the virtual database system management module 102, the OS calls the measurement module 212 to instruct the measurement module to start measurement of a latency (data acquisition time) (step S202).

In a case where the OS 101 receives a request for stopping the measurement module 212 from the virtual database system management module 102, the OS instructs the measurement module 212 to stop the process (step S203). In this case, the OS 101 acquires the latency measured by the measurement module 212 and calculates a score based on the latency. The OS 101 stores the score in a work area.

In a case where the OS 101 receives a cache registration request from the virtual database system management module 102, the OS outputs a writing request to the cache driver 211 (step S204). The writing request includes the score and the data acquired from the target database 122.

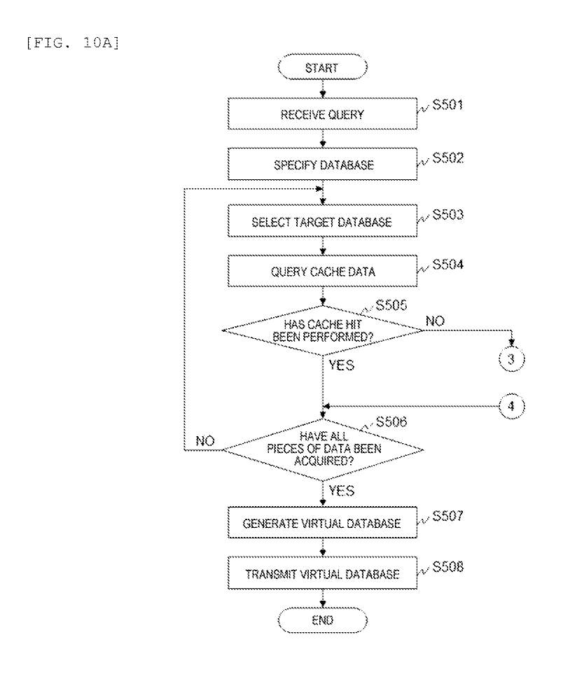

FIG. 8 is a flowchart illustrating an example of processing in a case where the cache driver 211 of Example 1 retrieves cache data.

The cache driver 211 retrieves data (cache data) of the target database 122 with reference to the cache area 111 of the cache memory system 110 (step S301).

The cache driver 211 determines whether or not cache data is stored in the cache memory system 110 based on retrieval results (step S302).

In a case where it is determined that cache data is stored in the cache memory system 110, the cache driver 211 reads out the cache data from the cache area 111 and outputs the cache data to the OS 101 (step S303).

In a case where it is determined that cache data is not stored in the cache memory system 110, the cache driver 211 notifies the OS 101 of a cache miss (step S304).

Meanwhile, after the processing shown in FIG. 7 is performed, the OS 101 outputs a response including the output of the cache driver 211 to the control module 221.

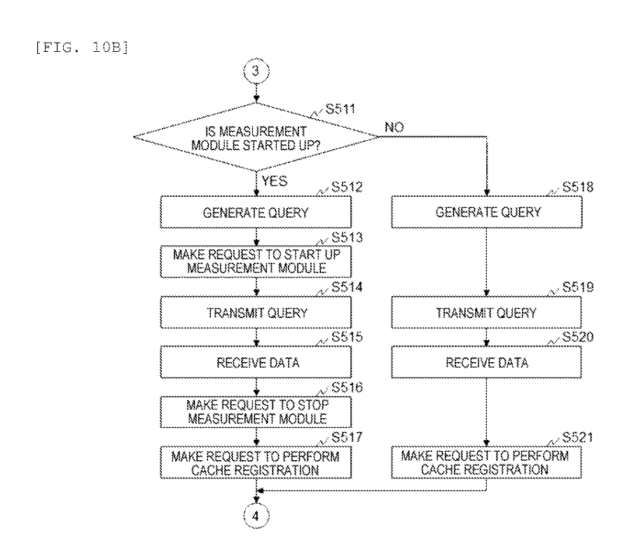

FIG. 9 is a flowchart illustrating an example of processing in a case where the cache driver 211 of Example 1 stores data in the cache area 111.

In a case where the cache driver 211 receives a writing request, it is determined whether or not a storage area for storing data received from the target database 122 is present in the cache memory system 110 (step S401).

In a case where it is determined that a storage area for storing data received from the target database 122 is present in the cache memory system 110, the cache driver 211 stores the data in a predetermined cache area 111 (step S402). Thereafter, the cache driver 211 updates the cache management information 213 and the latency information 214 (step S405).

Specifically, the cache driver 211 adds as many entries as the cache areas 111 storing data to the latency information 214 and sets an address of the cache area 111 storing data in addresses 501 of the added entries. The cache driver 211 sets a score calculated by the OS 101 in the latency scores 502 of all of the added entries. In this case, the scores set in the entries have the same value.

In a case where it is determined in step S401 that a storage area for storing data received from the target database 122 is not present in the cache memory system 110, the cache driver 211 selects cache data to be removed from the cache memory system 110 based on the cache management information 213 and the latency information 214 (step S403). For example, the following processing is conceivable.

In a case of the cache management information 213 shown in FIG. 4A, the cache driver 211 calculates an evaluation value based on an access frequency 402 and a latency score 502 of an entry in which an address 401 and an address 501 are consistent with each other. The access frequency 402, a total value and a multiplication value of the latency score 502, and the like may be conceived as the evaluation value. The cache driver 211 selects cache data to be removed, based on the evaluation value. For example, the cache driver 211 selects cache data to be removed in ascending order of an evaluation value.

In a case of the cache management information 213 shown in FIG. 4B, the cache driver 211 calculates an evaluation value based on the order of the structures 410 having the address 411 and the address 501 consistent with each other and the latency score 502. The order of the structures 410, a total value and a multiplication value of the latency scores 502, and the like are conceivable as the evaluation value. The cache driver 211 selects cache data to be removed, based on the evaluation value. For example, the cache driver 211 selects cache data to be removed in ascending order of an evaluation value.

Meanwhile, the evaluation value corresponds to a value obtained by correcting the cache management information 213 based on a score. For example, a case of an LFU method indicates that an access frequency is corrected based on a score, and a case of an LRU method indicates that the order of the structures 410 is corrected based on a score.

The cache driver 211 stores new data in the cache area 111 in which selected cache data is stored (step S404). Thereafter, the cache driver 211 updates the cache management information 213 and the latency information 214 (step S405).

Specifically, the cache driver 211 retrieves an entry in which the address 501 of the latency information 214 is consistent with the address of the selected cache area 111. The cache driver 211 sets a score calculated by the OS 101 in the latency score 502 of the retrieved entry.

Meanwhile, the cache driver 211 and the measurement module 212 may not be included in the OS 101. That is, the cache driver 211 and the measurement module 212 may be realized as modules different from the OS 101.

According to Example 1, it is possible to improve reference performance of a virtual database by performing cache control based on cache management information having a latency reflected therein.

Further, in Example 1, the virtual database system management module 102 may simply call the measurement module 212 and instruct the measurement module to register cache data, and thus it is possible to realize the existing application without making a great change.

### Example 2

In Example 2, the virtual database system management device 100 has a function of switching between two operation modes. One operation mode is a mode for performing cache control using the latency information 214, and the other operation mode is a mode for performing cache control not using the latency information 214. Hereinafter, Example 2 will be described focusing on differences from Example 1.

A configuration of a computer system of Example 2 is the same as the configuration of the computer system of Example 1. In addition, configurations of devices of Example 2 are the same as the configurations of the devices of Example 1.

Example 2 is different from Example 1 in that information (syntax) for giving an instruction for starting up the measurement module 212 is included in a query issued by the application 131.

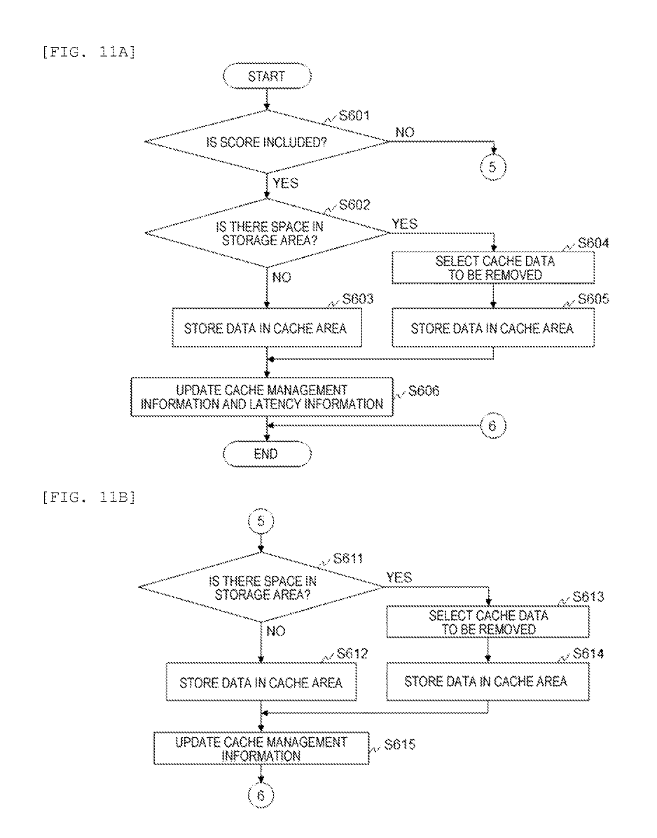

FIGS. 10A and 10B are flowcharts illustrating an example of processing executed by the virtual database system management module 102 of Example 2.

Processes of steps S501 to S508 are the same as the processes of steps S101 to S108.

In a case where it is determined in step S505 that a cache miss has occurred, the virtual database system management module 102 determines whether or not the measurement module 212 is started up based on analysis results of the query (step S511).

Specifically, the virtual database system management module 102 determines whether or not information for giving an instruction for starting up the measurement module 212 is included in the query issued by the application 131. In a case where information for giving an instruction for starting up the measurement module 212 is included in the query, the virtual database system management module 102 determines that the measurement module 212 is started up.

In a case where it is determined that the measurement module 212 is started up, the virtual database system management module 102 executes processes of steps S512 to S517 and then proceeds to step S506. Meanwhile, the processes of steps S512 to S517 are the same as the processes of steps S111 to S116.

In a case where it determined that measurement module 212 is not started up, the control module 221 generates a query for making an inquiry to the target database 122 (step S518) and transmits the generated query to the target database 122 (step S519).

Further, in a case where the control module 221 receives data from the target database 122 through the database interface 223 (step S520), the control module stores the received data in a work area and outputs a cache registration request for registering the data stored in the work area in the cache area 111 to the OS 101 (step S521). Thereafter, the control module 221 proceeds to step S506.

Meanwhile, the processes of steps S518, S519, S520, and S521 are the same as the processes of steps S111, S113, S114, and S118.

Processing executed by the OS 101 is the same as that in Example 1. However, in a case where the measurement module 212 is not required to be started up, the processes of steps S202 and S203 are omitted. Further, in step S204, a writing request not including a score is input to the cache driver 211.

Processing in a case where the cache driver 211 retrieves cache data is the same as that in Example 1

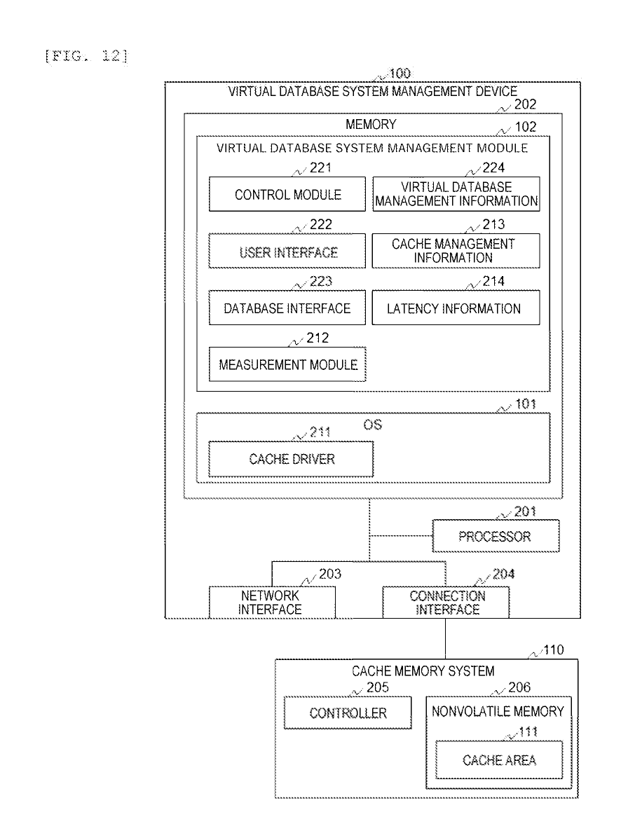

FIGS. 11A and 11B are flowcharts illustrating an example of processing in a case where the cache driver 211 of Example 2 stores data in the cache area 111.

In a case where the cache driver 211 receives a writing request, it is determined whether or not a score is included in the writing request (step S601).

In a case where it is determined that a score is included in the writing request, the cache driver 211 proceeds to step S602. Processes of steps S602 to S606 are the same as the processes of steps S401 to S405.

In a case where it is determined that a score is not included in the writing request, the cache driver 211 determines whether or not a storage area for storing data received from the target database 122 is present in the cache memory system 110 (step S611). The process of step S611 is the same as the process of step S401.

In a case where it is determined that a storage area for storing data received from the target database 122 is present in the cache memory system 110, the cache driver 211 stores the data in a predetermined cache area 111 (step S612). Thereafter, the cache driver 211 updates the cache management information 213 (step S615). Thereafter, the cache driver 211 terminates the processing.

Meanwhile, steps S612 and S615 are the same processes as known cache control, and thus a detailed description thereof will be omitted.

In a case where it is determined in step S611 that a storage area for storing data received from the target database 122 is not present in the cache memory system 110, the cache driver 211 selects cache data to be removed from the cache memory system 110 based on the cache management information 213 (step S613). In addition, the cache driver 211 stores new data in the cache area 111 in which the selected cache data is stored (step S614). The cache driver 211 updates the cache management information 213 (step S615). Thereafter, the cache driver 211 terminates the processing.

Meanwhile, the processes of steps S613, S614, and S615 are the same as known cache control processing, and thus a detailed description thereof will be omitted.

According to Example 2, a user can appropriately switch cache control.

### Example 3

In Example 3, the virtual database system management module 102 has a function of cache control. Hereinafter, Example 3 will be described focusing on differences from Example 1.

A configuration of a computer system of Example 3 is the same as the configuration of the computer system of Example 1. In Example 3, a software configuration of the virtual database system management device 100 is different from that in Example 1.

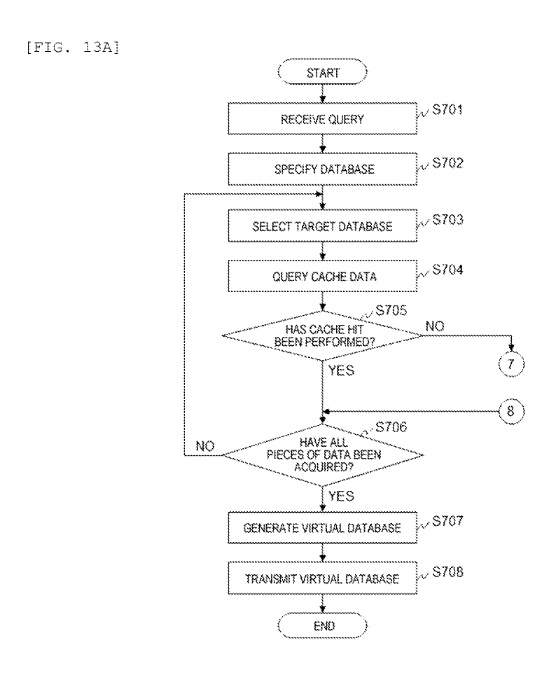

FIG. 12 is a diagram showing an example of detailed configurations of the virtual database system management device 100 and the cache memory system 110 of Example 3.

A hardware configuration of the virtual database system management device 100 is the same as that in Example 1. In Example 3, the virtual database system management module 102 includes the measurement module 212 and holds the cache management information 213 and the latency information 214.

Meanwhile, addresses stored in the addresses 401, 411, and 501 of the cache management information 213 and the latency information 214 are addresses in a virtual address space recognized by the virtual database system management module 102. In addition, the virtual database system management module 102 recognizes the cache area 111 in units of a page.

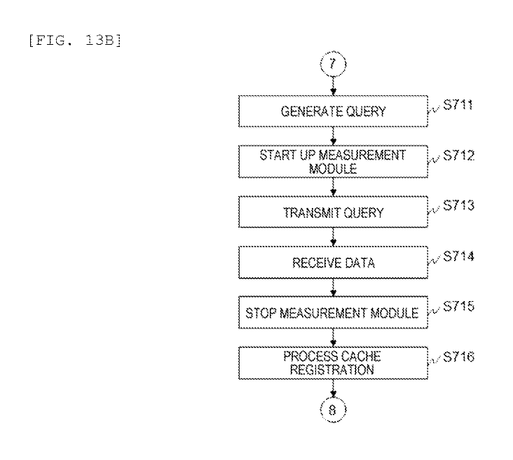

FIGS. 13A and 13B are flowcharts illustrating an example of processing executed by the virtual database system management module 102 of Example 3.

Processes of steps S701 to S708 are the same as the processes of steps S101 to S108.

In a case where it is determined in step S705 that a cache miss has occurred, the control module 221 generates a query (step S711) and starts up the measurement module 212 (step S712). The process of step S711 is the same as the process of step S111. In Example 3, the virtual database system management module 102 includes the measurement module 212, and thus the control module 221 directly calls the measurement module 212.

Processes of steps S713 and S714 are the same as the processes of steps S113 and S114. After the process of step S714 is executed, the control module 221 instructs the measurement module 212 to stop the process (step S715). In this case, the control module 221 acquires a latency from the measurement module 212 and calculates a score based on the latency. The control module 221 stores the score in a work area.

The control module 221 executes cache registration processing (step S716). Thereafter, the control module 221 proceeds to step S706.

Contents of the cache registration processing executed by the control module 221 are the same as the contents of the processing shown in FIG. 9. However, the control module 221 writes data in a free space of the cache memory system 110 or the cache memory system 110 through the cache driver 211.

According to Example 3, it is possible to realize a system having the same effects as those in Example 1 without changing the existing OS 101.

Meanwhile, the present invention is not limited to the examples described above and includes various modification examples. In addition, for example, the examples described above are described in detail for easy understanding of the present invention and are not necessarily limited to those including all of the configurations described above. Further, addition, deletion, and substitution of a portion of the configurations of the examples can be performed on another configuration.

In addition, with regard to the above-described configurations, functions, processing units, processing means, and the like, a portion or the entirety thereof may be realized by hardware, for example, by being designed as an integrated circuit. Further, the present invention can also be realized by a program code of software for realizing the functions of the examples. In this case, a storage medium having the program code recorded thereon is provided to a computer, and a CPU included in the computer reads out the program code stored in the storage medium. In this case, the program code itself read out from the storage medium realizes the functions of the above-described examples, so that the program code itself and the storage medium having the program code recorded thereon constitute the present invention. As the storage medium for supplying such a program code, a flexible disk, a CD-ROM, a DVD-ROM, a hard disk, a solid state drive (SSD), an optical disc, a magneto-optical disc, a CD-R, a magnetic tape, a non-volatile memory card, a ROM, and the like are used.

In addition, the program code for realizing the functions described in the present examples can be implemented in a wide range of programming or scripting languages, such as Assembler, C/C++, Peri, Shell, PHP, and Java.

Further, the program code of the software for realizing the functions of the examples is distributed through a network, so that the program code maybe stored in storage means such as a hard disk or a memory of a computer or a storage medium such as a CD-RW or a CD-R and a CPU included in the computer may read out and execute the program code stored in the storage means or the storage medium.

In the above-described examples, control lines and information lines that are assumed to be necessary for the sake of description are illustrated, but not all the control lines and the information lines on a product are illustrated. All the components may be connected to each other.

1. A computer that generates a virtual database generated by integrating a plurality of databases, the computer comprising:
a processor;
a memory connected to the processor;
a network interface connected to the processor; and
a connection interface connected to the processor,
wherein the computer is connected to a plurality of databases systems managing a database and a cache memory system providing a cache area for storing data acquired from the database,
the computer holds virtual database management information for managing a plurality of databases constituting the virtual database, cache management information used for cache control, and latency information for managing a latency when data is acquired from the databases, and
the processor specifies a plurality of target databases constituting the virtual database based on analysis results of a query and the virtual database management information when the query for referring to the virtual database is received, acquires data in which cache data is stored in the cache memory system, among pieces of data of the plurality of target databases, from the cache memory system, acquires data in which cache data is not stored in the cache memory system, among pieces of data of the plurality of taraet databases, from the plurality of target databases, generates the virtual database using the cache data acquired from the cache memory system and the data acquired from the plurality of specified databases, calculates an evaluation value of the cache area based on the cache management information and the latency information in a case where the cache area for storing the data acquired from the plurality of target databases is not sufficient, selects the cache area from which cache data is to be deleted, based on the evaluation value, and stores the data acquired from the plurality of target databases in the selected cache area.

2. The computer according to claim 1, wherein
the latency information includes an entry constituted by an address of the cache area and the latency, and
the processor measures an acquisition time required in a case where data is acquired from the plurality of target databases as the latency, retrieves an entry corresponding to the selected cache area after the data acquired from the plurality of databases is stored in the selected cache area, and sets the latency in the retrieved entry.

3. The computer according to claim 2, wherein
the cache management information includes an entry constituted by an address of the cache area and an access frequency with respect to the cache area, and
the processor calculates the evaluation value based on the access frequency of the cache area and the latency.

4. The computer according to claim 2, wherein
the cache management information is a list of addresses of the cache areas, and
the processor calculates the evaluation value based on the order of the cache areas in the list and the latency.

5. The computer according to claim 2, wherein
the query includes information indicating whether or not measurement of the latency is performed, and
the processor measures the latency in a case where the query including information for giving an instruction for measuring the latency is received, and selects the cache area from which the cache data to be deleted based on the cache management information in a case where the query not including information for giving an instruction for measuring the latency is received.

6. A cache control method in a computer that generates a virtual database generated by integrating a plurality of databases, wherein
the computer includes a processor, a memory connected to the processor, a network interface connected to the processor, and a connection interface connected to the processor,
the computer is connected to a plurality of databases systems managing a database and a cache memory system providing a cache area for storing data acquired from the database,
the computer holds virtual database management information for managing a plurality of databases constituting the virtual database, cache management information used for cache control, and latency information for managing a latency when data is acquired from the databases, and
the processor includes:
a first step of specifying a plurality of target databases constituting the virtual database based on analysis results of a query and the virtual database management information when the query for referring to the virtual database is received;
a second step of acquiring data in which cache data is stored in the cache memory system, among pieces of data of the plurality of target databases, from the cache memory system;
a third step of acquiring data in which cache data is not stored in the cache memory system, among pieces of data of the plurality of target databases, from the plurality of target databases;
a fourth step of generating the virtual database using the cache data acquired from the cache memory system and the data acquired from the plurality of specified databases;
a fifth step of calculating an evaluation value of the cache area based on the cache management information and the latency information in a case where the cache area for storing the data acquired from the plurality of target databases is not sufficient;
a sixth step of selecting the cache area from which cache data is to be deleted, based on the evaluation value; and
a seventh step of storing the data acquired from the plurality of target databases in the selected cache area.

7. The cache control method according to claim 6, wherein
the latency information includes an entry constituted by an address of the cache area and the latency,
the third step includes a step of causing the processor to perform a step of measuring an acquisition time required in a case where data is acquired from the plurality of target databases as the latency, and
the seventh step includes a step of causing the processor to retrieve an entry corresponding to the selected cache area after the data acquired from the plurality of databases is stored in the selected cache area and a step of causing the processor to set the latency in the retrieved entry.

8. The cache control method according to claim 7, wherein
the cache management information includes an entry constituted by an address of the cache area and an access frequency with respect to the cache area, and
in the fifth step, the processor calculates the evaluation value based on the access frequency of the cache area and the latency.

9. The cache control method according to claim 7, wherein
the cache management information is a list of addresses of the cache areas, and
in the fifth step, the processor calculates the evaluation value based on the order of the cache areas in the list and the latency.

10. The cache control method according to claim 7, wherein
the query includes information indicating whether or not measurement of the latency is performed,
in the third step, the processor measures the latency in a case where the query including information for giving an instruction for measuring the latency is received, and
in the sixth step, the processor selects the cache area from which the cache data to be deleted based on the cache management information in a case where the query not including information for giving an instruction for measuring the latency is received.
